(19) United States
(12) Patent Application Publication
(10) Pub. No.: US 2018/0141403 A1
(43) Pub. Date: May 24, 2018

(54) AIR CONTROL APPARATUS

(71) Applicant: Mahle International GmbH, Stuttgart (DE)

(72) Inventor: Michael Komowski, Weil Der Stadt (DE)

(21) Appl. No.: 15/818,722

(22) Filed: Nov. 20, 2017

(30) Foreign Application Priority Data
Nov. 21, 2016 (DE) 10 2016 222 918.4

(51) Int. Cl. B60H 1/00; B60H 1/34

(52) U.S. Cl. CPC B60H 1/00035; B60H 1/0055; B60H 2001/3485; B60H 2001/00171; B60H 2001/3471; B60H 1/3421

(57) ABSTRACT

An air control apparatus for an air conditioning system may include a housing defining at least one duct and at least one flap. The at least one flap may comprise a shaft having at least one projecting wing. At least one longitudinal end of the shaft may be rotatably mounted about an axis of rotation on a wall of the housing via a bearing opening. The bearing opening may include an offset region and a bearing region. The offset region may have a larger inner diameter than the bearing region. A sealing contour may be disposed on the at least one wing and a counter-sealing contour may be disposed on the associated wall.

### CROSS-REFERENCE TO RELATED APPLICATIONS

This application claims priority to German Patent Application No.: DE 10 2016 222 918.4 filed on Nov. 21, 2016, the contents of which are incorporated herein by reference in its entirety.

### TECHNICAL FIELD

The present invention relates to an air control apparatus for an air conditioning system with a housing for forming at least one duct for conducting an air flow. The invention additionally relates to an air conditioning system for a vehicle for air conditioning a vehicle interior with at least one such air control apparatus.

### BACKGROUND

From EP 0 925 969 B1 an air control apparatus for an air conditioning system is known, which comprises a housing for forming at least one duct for conducting an air flow and at least one flap for controlling the air flow in the duct, wherein the flap is rotatably mounted about an axis of rotation in the housing for opening and closing the duct. For this purpose, the flap comprises a shaft from which at least one wing projects. The shaft is rotatably mounted about the axis of rotation at least at one of its longitudinal ends on a ball of the housing serving as support structure. The air control apparatus formed here comprises a bearing opening formed in the support structure, through which the shaft projects. Furthermore, the air control apparatus is equipped with an annular seal arranged coaxially to the axis of rotation for sealing the bearing opening. In the known air control apparatus, the seal is formed by an annular sealing gap that is arranged coaxial to the axis of rotation, which sealing gap is radially formed between an annularly circumferential cylindrical inner wall that is arranged on the shaft in a fixed manner and an annular circumferential cylindrical outer wall arranged on the support structure.

From DE 10 2014 217 163 A1 an air control apparatus for an air conditioning system with an annular seal arranged coaxially to the axis of rotation for sealing the bearing opening is likewise known. Here, this seal is formed as a labyrinth seal and comprises at least one annular rib and at least one annular groove, into which the rib axially projects. Between two outer walls of the rib facing away from one another and two walls of the groove facing one another, an inner sealing gap and an outer sealing gap are formed, which in each case are configured annularly and arranged coaxially to the axis of rotation. An improved sealing is to be achieved by this.

From DE 10 2007 026 620 B4 a duct opening/closing device is known, with a housing defining a first fluid duct and a second fluid duct in said housing. The device furthermore comprises a first flap which is arranged in such a manner that it opens and closes the first fluid duct, and a second flap which is arranged in such a manner that it opens and closes the second fluid duct. Here, the first flap comprises a first pivot shaft and a first flap body, which is moveable with the first pivot shaft, wherein this first pivot shaft has a first and a second end. In the same way, the second flap comprises a second pivot shaft and a second flap body, which is moveable with the second pivot shaft. The second pivot shaft in this case is orientated to the first pivot shaft of the first flap. In particular an improved opening and closing is to be achieved by this.

Generally, a high level of tightness is demanded with air control apparatuses for air conditioning systems, which with closed flap does not allow any or only a marginal air leakage. Because of comparatively large dimensional tolerances of plastic components employed in this field and the heat expansions that occur during the operation, a multiplicity of elastic sealing bodies or elaborate sealing geometries have to be employed however in order to satisfy this requirement.

### SUMMARY

The present invention deals with the problem of stating an improved or at least an alternative embodiment for an air control apparatus of the generic type, which is constructed in particular simply and cost-effectively, while having a high level of tightness with closed flap.

According to the invention, this problem is solved through the subject of the independent claims. Advantageous embodiments are subject of the dependent claims.

The present invention is based on the general idea of mounting a flap of an air control apparatus of an air conditioning system by means of an entirely new type of bearing concept, which can in particular easily offset dimensional tolerances which occur with plastic injection moulded parts due to the process and at the same time manages to do without the elaborate seals employed for this purpose to date. The air control apparatus according to the invention comprises a housing for forming at least one duct for conducting an air flow. For controlling the air flow in the duct, at least one flap is provided, which is rotatably arranged about an axis of rotation on the housing for opening and closing the duct. The flap comprises a shaft, or a shaft section, from which at least one wing projects, wherein the shaft, at least at one of its longitudinal ends, is rotatably mounted about the axis of rotation on a wall of the housing. In the wall, a bearing opening is formed into which the shaft projects or through which the shaft projects. On its inner circumference, the bearing opening has a cylindrical inner bearing surface that is arranged coaxially to the axis of rotation. According to the invention, the bearing opening now comprises an offset region and a bearing region comprising the cylindrical inner bearing surface, wherein the offset region has a larger inner diameter than the bearing region. The shaft, in turn, comprises a first shaft section at least at one of its longitudinal ends, the outer diameter of which substantially corresponds to the inner diameter of the offset region of the bearing opening, and a second shaft section, the outer diameter of which substantially corresponds to the inner diameter of the bearing region of the bearing opening, i.e. to the inner diameter of the inner bearing surface. The first shaft section and the associated offset region in this case serve primarily for sealing, so that an annular clearance of approximately 0.1 mm can be determined as tolerance here. The second shaft section and the bearing region serve for mounting the shaft so that here the dimensions are furnished with closer tolerances and an annular clearance for example amounts to 0.05 mm. On the at least one wing, a sealing contour, for example a sealing lip, is additionally arranged while on the associated wall a counter-sealing contour, for example likewise a sealing lip, is arranged, wherein the two contours extend up to the first shaft section and, with closed flap, lie tightly against one another, i.e. overlap one another, and because of this preferentially seal the duct at least almost air-tight. By extending the sealing contour and the counter-sealing contour up to the first shaft section, a flap-side sealing profile with oversize relative to the housing that has been previously employed in the bearing region with saved housing stop ribs (for the tulip geometry of the flap) can be omitted. The offset region and the bearing region of the bearing opening as well as the two shaft sections of the flap are now dimensioned according to the invention in such a manner that the flap in the closed state with the first shaft section is at least partly guided in the offset region and with the second shaft section at least partly guided in the bearing region and the sealing contour tightly lies against the counter-sealing contour at the same time. Through the stepped mounting of the flap it is possible for the first time to absorb dimensional tolerances which occur due to the process with plastic injection moulded parts without elaborate sealing geometries, for example sealing tulips, which had to be provided for this purpose in the past, being required. The actual pivot mounting of the flap is affected by way of the second shaft section in the bearing region of the bearing opening with the inner bearing surface, while a sealing of the flap relative to the housing or to the bearing opening is affected via the first shaft section and the offset region of the bearing opening. This is important, in particular if the bearing opening is designed as an open bearing opening, through which for example a driveshaft of an actuating device, for example of an electric motor, for adjusting the flap, is additionally passed. With the air control apparatus according to the invention, a simple and robust mounting of the flap can thus be achieved which does not require any additional lubrication. A particular advantage, furthermore, is that a simple and in particular also blind assembly of the flap in the bearing opening is possible, since because of the shaft sections and regions which are designed complementarily to one another a simple insertion of the shaft sections into the associated regions of the bearing opening is possible. In addition, the axial tolerance offset, which serves for absorbing dimensional tolerances due to the manufacture, is practically unlimited. It is also a decisive advantage that the air control apparatus according to the invention is universally employable, i.e. both with split and also non-split housings and also with flaps mounted on one or two sides.

In an advantageous further development of the solution according to the invention, the first shaft section is arranged with axial clearance relative to the bearing region of the bearing opening. Because of this it can be ensured that the step that is present between the first and second shaft section never abuts the associated step between the offset region and the bearing region of the bearing opening in axial direction and thereby bring about for example a jamming of the flap.

Practically, the sealing contours or the counter-sealing contour are formed as elastic sealing lip. With respect to their width, i.e. their extension in axial direction of the shaft of the flap, the sealing lips are dimensioned so that they always lie tightly against one another with the flap in the closed state regardless of the dimensional tolerances of the flap that occur due to the manufacture. The elastic sealing lips can be subsequently attached to the wall of the housing or to the wing of the flap, wherein with a particularly advantageous embodiment of the solution according to the invention it is also conceivable that the sealing contour, i.e. the sealing lip, is formed in one piece with the flap, in particular produced or injection moulded onto the wing in a common plastic injection moulding process.

In a further advantageous embodiment of the solution according to the invention, the shaft is designed, at least in the region of the second shaft section, as a hollow shaft with an engagement contour that is formed in particular as an internal polygon profile. Because of this, a comparatively simple drive of the flap for adjusting the same is conceivable between its opening and closing state, for the purpose of which merely an actuating device, for example an electric motor with a driveshaft has to be provided. Here, the driveshaft can have an outer contour that is formed complementarily to the engagement contour, so that the driveshaft can be inserted into the engagement contour in a rotationally fixed manner. To this end, the driveshaft comprises for example an external polygon profile. By way of the combination of the shaft with the internal polygon profile with the driveshaft of the actuating device with the external polygon profile, a longitudinal slidability between the flap in axial direction of its shaft relative to the driveshaft of the electric motor can also be ensured without fearing that the drive of the flap is rendered impossible because of this. In the second shaft section of the shaft and of the driveshaft of the actuating device, a longitudinally displaceable torque-transmitting form-fit is realised here.

In an advantageous further development of the solution according to the invention, the bearing opening is designed open or as a blind hole opening. Here, it is conceivable for example that the bearing opening at a longitudinal end of the flap is designed as a blind hole opening and open at the other longitudinal end, wherein in the case of the open bearing opening the drive of the flap is affected. In the region of the closed blind hole opening, there is no leakage flow so that the sealing function provided according to the invention with the stepped shaft sections can be provided but not necessarily so.

According to an advantageous embodiment, the respective flap can comprise at least two wings which project from the shaft at different circumferential sections. A flap with exactly two wings can also be described as a butterfly flap. Such a flap is characterized in particular in that only comparatively low torques are required for adjusting the flap.

According to an advantageous further development, at least two wings of the flap can be different in size radially with regard to the axis of rotation. Because of this, the flap becomes asymmetrical which is advantageous for certain applications. In particular, the shaft can arrange itself more easily in an edge region of the respective duct.

In another advantageous further development it can be provided that the flap comprises exactly two wings which in the circumferential direction include a wing angle of 180°. This design also supports complex installation situations.

An air conditioning system according to the invention, which in a vehicle serves for air conditioning a vehicle interior, is equipped with an air control apparatus of the type described above. Here, at least one such flap can serve for adjusting a mixing ratio between circulating air and fresh air. Additionally or alternatively, at least one such flap can serve for adjusting a mixing ratio between warm air and cold air. Additionally or alternatively, at least one such flap in the housing can serve for adjusting a volumetric flow for the air flow in the respective duct. Thus, different functions materialise for the respective flap.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

Here it shows, in each case schematically,

FIG. 1 an exploded representation of an air control apparatus according to the invention in the region of a flap and an associated bearing opening,

FIG. 2 a representation according to FIG. 1, however with installed flap,

FIG. 3 a detail representation from FIG. 2,

FIG. 4 an axial view onto the flap and the bearing opening,

FIG. 5 a sectional representation along the section plane A-A from FIG. 4,

FIG. 6 a detail view of the flap in the region of its shafts with first and second shaft section.

### DETAILED DESCRIPTION OF THE DRAWINGS

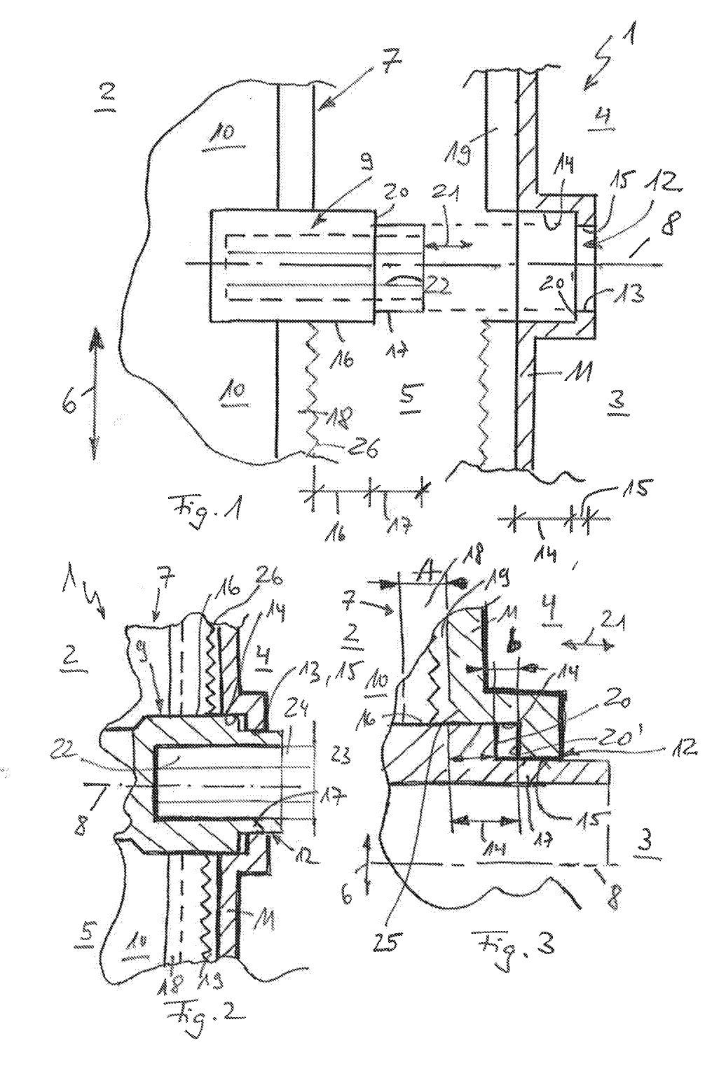

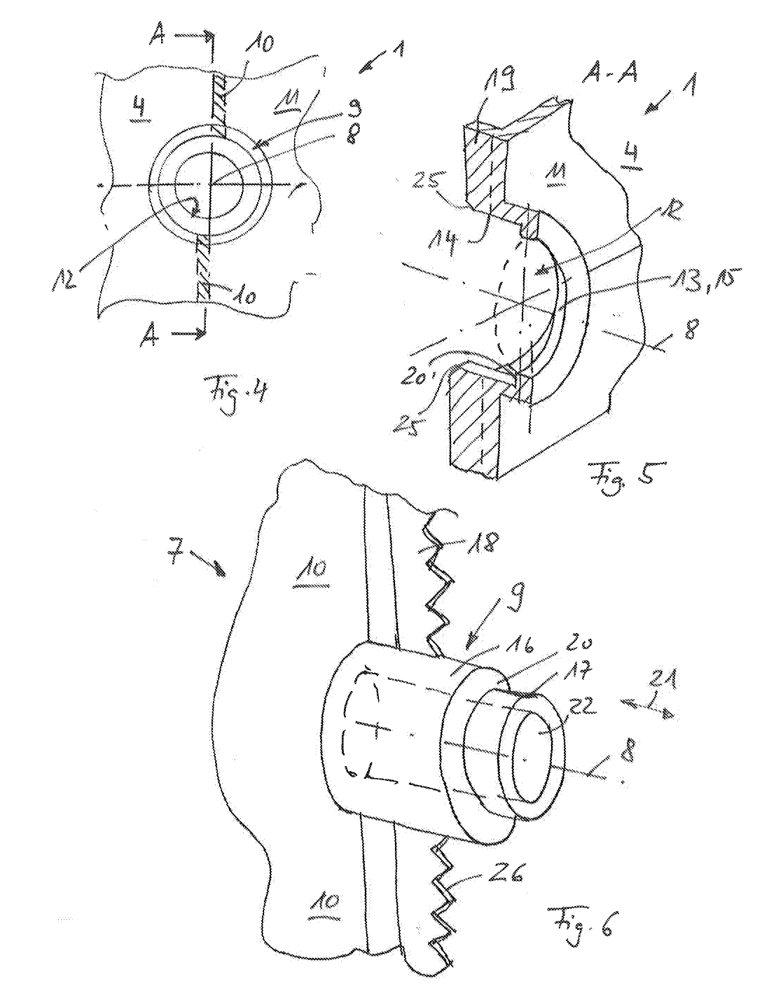

According to FIG. 1, an air control apparatus 1 for an air conditioning system 2 in a vehicle 3 which is not shown in more detail comprises a housing 4 for forming at least one duct 5 for conducting an air flow 6. The air control apparatus 1 according to the invention comprises at least one flap 7 for controlling the air flow 6 in the duct 5, which is rotatably arranged or mounted on the housing 4 about an axis of rotation 8 for opening and closing the duct 5. The flap 7 has a shaft 9 from which at least one wing 10 projects. Here, the shaft 9 obviously need not be formed continuously through the flap 7 but can also be connected to the flap 7 at a respective axial longitudinal end of the same. At least at one of its longitudinal ends, the shaft 9 is rotatably mounted about the axis of rotation 8 on a wall 11 of the housing 4 serving as support structure. In the wall 11 or in the support structure, a bearing opening 12 (see also FIGS. 2 to 5) is provided, into which the shaft 9 projects or through which the shaft 9 projects. Here, the bearing opening 12 has a cylindrical inner bearing surface 18 on its inner circumference which is arranged coaxially to the axis of rotation 8.

According to the invention, the bearing opening 12 now has an offset region 14 and a bearing region 15, wherein the bearing region 15 forms the inner bearing surface 13. The shaft 9 in turn has a first shaft section 16 at least at one of its longitudinal ends, the outer diameter of which substantially corresponds to the inner diameter of the offset region 14 of the bearing opening 12, and a second shaft section 17, the outer diameter of which substantially corresponds to the inner diameter of the bearing region 15, i.e. to the inner diameter of the inner bearing surface 13 of the bearing opening 12. On at least one wing 10, a sealing contour 18 is additionally arranged, while on the associated wall 11 a counter-sealing contour 19 is provided, both of which are extended up to the first shaft section 16 of the shaft 9 and which, with closed flap 7, tightly lie against one another, i.e. overlap one another.

The offset region 14 and the bearing region 15 of the bearing opening 12 as well as the two associated shaft sections 16, 17 of the shaft 9 are additionally dimensioned in such a manner that the flap 7 in the closed state is guided with the first shaft section 16 at least partly in the offset region 14 and with the second shaft section 17 at least partly in the bearing region 15 and the sealing contour 18 lies tightly against the counter-sealing contour 19, i.e. overlaps the same. The first shaft section 16 and the associated offset region 14 serve primarily for sealing, so that an annular clearance of for example approximately 0.1 mm can be determined as tolerance. The second shaft section 17 and the bearing region 15 by contrast serve for mounting the shaft 9 so that the dimensions in this case are furnished with a closer tolerance and an annular clearance is correspondingly smaller, e.g. only 0.05 mm.

With the mounting of the flap 7 in the bearing opening 12 according to the invention it is possible for the first time to absorb production-induced dimensional tolerances of the flap 7, in particular in the axial direction of the shaft 9, i.e. in the direction of the axis of rotation 8, without having to make use of elaborate sealing geometries or seals, such as for example sealing tulips in this region as in the past. Depending on manufacturing-induced dimensional tolerance, the shaft 9 with its respective shaft sections 16, 17 engages in the associated regions 14, 15 of the bearing opening 12 to different depths, wherein however with closed flap 7 the sealing contours 18 tightly lie against the counter-sealing contours and through the at least partial engaging of the first shaft section 6 in the associated offset region 14 of the bearing opening 12 and of the second shaft section 17 in the associated bearing region 15 both a sealing of the bearing opening 12 and also a reliable mounting of the flap 7 can be achieved. The offset region 14 in this case serves as sealing region. By way of the sealing contour 18 and counter-sealing contour 19 extended up to the first shaft section 16, an undesirable leakage flow can be almost entirely avoided in this region. The sealing contour 18 and/or the counter-sealing contour 19 can additionally have a serrated edge 26 in order to prevent in particular an undesirable noise development, for example by way of whistling, when closing the flap 7.

With the air control apparatus 1 according to the invention, a simple, tolerance absorbing and robust mounting of the flap 7 can thus be made possible, which neither requires additional lubricating, for example greases, nor elaborate seals. In addition, the flap 7 can be mounted comparatively easily, in particular even blind, since the second shaft section 7 forms a kind of insertion bevel. Purely theoretically, providing a genuine bevel 25 is even conceivable (see FIG. 3). With the mounting according to the invention, the axial tolerance offset is possible practically without limits. In addition, the solution according to the invention can be employed both with split and also with non-split housing parts, just as with flaps 7 that are mounted merely on one side or on both sides. Because of this, a long lifespan of the flap 7 and a cost-effective tool can be achieved.

Looking at the representation according to FIGS. 2 and 3, it is evident that the first shaft section 16 is arranged with axial clearance b relative to the bearing region 15 of the bearing opening 12 so that the step 20 between the first shaft section 16 and the second shaft section 17 of the shaft 9 independently of the production-related dimensional tolerances, never abuts the associated state step 20′ in the axial direction 21 between the offset region 14 and the bearing region 15 of the bearing opening 12 and because of this could for example result in a jamming of the flap.

The sealing contour 18 and the counter-sealing contour 19 can be formed for example as sealing lips which are either subsequently arranged on the wing 10 of the flap 7 or on the wall 11 of the housing 4. Alternatively, it is also conceivable in particular with the flap 7 that the sealing contour 9 provided there is injection moulded together with the same and thus produced comparatively easily.

Looking at in particular the FIGS. 1, 2 and 3 it is evident that the shaft 9, at least in the region of the second shaft section 17, but usually obviously also in the first shaft section 16 is formed as a hollow shaft with an engagement contour 22 that is formed in particular as an internal polygon profile. For adjusting the flap 7, an actuating device, for example an electric motor 23 (see FIG. 2) can be provided, the driveshaft 24 of which is connected to the shaft 9 in a rotationally fixed manner, in particular subject to a form-fit engaging in the engagement contour 22. Through the form-fit yet longitudinally displaceable coupling transmitting torque of the driving device, for example of the electric motor 23 to the shaft 9 of the flap 7, production-induced dimensional tolerances can be comparatively easily offset as well.

Looking at the bearing opening 12 according to the FIGS. 1 to 5 it is evident that the same are designed open wherein it is obviously also clear that the same is closed on the opposite side, i.e. can be formed as a blind hole opening.

The flap 7 usually comprises at least two wings 10 which, at different circumferential sections of the shaft 9, project from the same. In the present case, the flap 7 comprises two wings 10 which lie in a plane and because of this project from the shaft 9 offset by 180°. The wings 10 can be different in size radially to the axis of rotation 8, but also identical in size.

By means of the air conditioning system 2, in which the air control apparatus 1 according to the invention is arranged, a mixing ratio between circulating air and fresh air and/or a mixing ratio between warm air and cold air and/or the adjusting of a volumetric flow of the air flow 6 in the respective duct 5 can be accomplished in particular, in each case dependent on the pivot position of the flap 7.

With the air control apparatus 1 according to the invention it is thus possible for the first time to mount an associated flap 7 despite production-induced dimensional tolerances of the same or of a housing 4 in the housing 4 in such a manner that these tolerances can be offset and the flap 7 always seals tightly in the closed state. This can be achieved in particular through the mounting according to the invention which is extremely simple in design and thus also cost-effective, which in particular no longer depends on the elaborate seals that have been required in this region up to now.

1. An air control apparatus for an air conditioning system comprising:
a housing defining at least one duct configured to conduct an air flow, the housing having at least one flap configured to control the air flow in the duct, the at least one flap arranged in the housing about an axis of rotation to open and close the duct;
wherein the at least one flap comprises a shaft having a first longitudinal end and a second longitudinal end and at least one projecting wing, wherein at least one of the first longitudinal end and the second longitudinal end is rotatably mounted about the axis of rotation on a wall of the housing, the wall having a bearing opening defined in the wall configured to accommodate at least a portion of the shaft;
wherein an inner circumference of the bearing opening has a cylindrical inner bearing surface arranged coaxially to the axis of rotation;
wherein the bearing opening includes an offset region and a bearing region, the offset region having a larger inner diameter than the bearing region;
wherein at least one of the first longitudinal end and the second longitudinal end includes a first shaft section having an outer diameter substantially corresponding to the inner diameter of the offset region of the bearing opening, and a second shaft section having an outer diameter substantially corresponding to the inner diameter of the bearing region of the bearing opening;
wherein a sealing contour is disposed on the at least one wing and a counter-sealing contour is disposed on the wall, the sealing contour and the counter-sealing contour extending up to the first shaft section and configured so that when the at least one flap is closed the sealing contour and the counter-sealing contour lie tightly against one another; and
wherein the offset region and the bearing region of the bearing opening and the first shaft section and the second shaft sections are configured so that when the at least one flap is in a closed state the first shaft section is at least partly guided in the offset region and the second shaft section is at least partly in the bearing region and the sealing contour lies tightly against the counter-sealing contour.

2. The air control apparatus according to claim 1, wherein the first shaft section is arranged with an axial clearance to the bearing region of the bearing opening.

3. The air control apparatus according to claim 1, wherein at least one of the sealing contour and the counter-sealing contour comprises an elastic sealing lip.

4. The air control apparatus according to claim 1, wherein at least a region of the second shaft section of the shaft is defined as a hollow shaft having an engagement contour.

5. The air control apparatus according to claim 4, further comprising an electric motor configured to adjust the flap, the electric motor having a driveshaft, wherein the driveshaft is connected to the shaft in a rotationally fixed manner.

6. The air control apparatus according to claim 1, wherein the bearing opening is one of an open hole or a blind hole opening.

7. The air control apparatus according to claim 1, wherein the flap comprises exactly two wings having a wing angle of 180° in a circumferential direction.

8. The air control apparatus according to claim 1, wherein at least one of: the at least one wing comprises at least two wings, the at least two wings being different in size radially to the axis of rotation; and the flap comprises a plastic injection moulded part.

9. An air conditioning system for a vehicle for air conditioning a vehicle interior comprising:
a housing defining at least one duct configured to conduct an air flow, the housing having at least one flap configured to control the air flow in the duct, the at least one flap arranged in the housing about an axis of rotation to open and close the duct;
wherein the at least one flap comprises a shaft having at least one projecting wing and a first longitudinal end and a second longitudinal end, wherein at least one of the first longitudinal end and the second longitudinal end is rotatably mounted about the axis of rotation on a wall of the housing, the wall having a bearing opening defined in the wall configured to accommodate at least a portion of the shaft;
wherein an inner circumference of the bearing opening has a cylindrical inner bearing surface arranged coaxially to the axis of rotation;
wherein the bearing opening includes an offset region and a bearing region, the offset region having a larger inner diameter than the bearing region;
wherein at least one of the first longitudinal end and the second longitudinal end includes a first shaft section having an outer diameter substantially corresponding to the inner diameter of the offset region of the bearing opening, and a second shaft section having an outer diameter substantially corresponding to the inner diameter of the bearing region of the bearing opening;
wherein a sealing contour is disposed on the at least one wing and a counter-sealing contour is disposed on the wall, the sealing contour and the counter-sealing contour extending up to the first shaft section and configured so that when the at least one flap is closed the sealing contour and the counter-sealing contour lie tightly against one another;
wherein the offset region and the bearing region of the bearing opening and the first shaft section and the second shaft section are configured so that when the at least one flap is in a closed state the first shaft section is at least partly guided in the offset region and the second shaft section is at least partly in the bearing region and the sealing contour lies tightly against the counter-sealing contour; and
wherein at least one of: the at least one flap is configured to adjust a mixing ratio between circulating air and fresh air; the at least one flap is configured to adjust a mixing ratio between warm air and cold air; and the at least one flap is configured to adjust a volumetric flow of the air flow in the respective duct.

10. The air control apparatus according to claim 1, wherein the flap comprises the plastic injection moulded part and the plastic injection moulded part is a one-piece plastic injection moulded part with the shaft, the at least one wing, and the sealing contour.

11. The air control apparatus according to claim 1, wherein the sealing contour and the counter-sealing contour extend up to the first shaft section and are configured so that when the at least one flap is closed the sealing contour and the counter-sealing contour overlap one another.

12. The air control apparatus according to claim 1, wherein the engagement contour comprises an internal polygon profile.

13. The air control apparatus according to claim 1, further comprising an electric motor configured to adjust the flap, the electric motor having a driveshaft, and wherein the driveshaft is connected to the shaft in a rotationally fixed manner.

14. The air control apparatus according to claim 1, wherein the bearing opening is an open hole opening.

15. The air control apparatus according to claim 1, wherein the bearing opening is a blind hole opening.

16. The air conditioning system of claim 9, wherein the at least one flap is configured to adjust a mixing ratio between circulating air and fresh air.

17. The air conditioning system of claim 9, wherein the at least one flap is configured to adjust a mixing ratio between warm air and cold air.

18. The air conditioning system of claim 9, wherein the at least one flap is configured to adjust a volumetric flow of the air flow in the respective duct.

19. An air control apparatus for an air conditioning system comprising:
a housing defining at least one duct configured to conduct an air flow, the housing having at least one flap configured to control the air flow in the duct, the at least one flap arranged in the housing about an axis of rotation to open and close the duct;
wherein the at least one flap comprises a shaft having a first longitudinal end and a second longitudinal end and at least one projecting wing, wherein at least one of the first longitudinal end and the second longitudinal end is rotatably mounted about the axis of rotation on a wall of the housing, the wall having a bearing opening defined in the wall configured to accommodate at least a portion of the shaft;
wherein an inner circumference of the bearing opening has a cylindrical inner bearing surface arranged coaxially to the axis of rotation;
wherein the bearing opening includes an offset region and a bearing region, the offset region having a larger inner diameter than the bearing region;
wherein at least one of the first longitudinal end and the second longitudinal end includes a first shaft section having an outer diameter substantially corresponding to the inner diameter of the offset region of the bearing opening, and a second shaft section having an outer diameter substantially corresponding to the inner diameter of the bearing region of the bearing opening;
wherein a sealing contour comprising an elastic sealing lip is disposed on the at least one wing and a counter-sealing contour comprising an elastic sealing lip is disposed on the associated wall, the sealing contour and the counter-sealing contour extending up to the first shaft section and configured so that when the at least one flap is closed the sealing contour and the counter-sealing contour lie tightly against one another;
wherein the offset region and the bearing region of the bearing opening and the first shaft section and the second shaft section are configured so that when the at least one flap is in a closed state the first shaft section is at least partly guided in the offset region and the second shaft section is at least partly in the bearing region and the sealing contour lies tightly against the counter-sealing contour; and
wherein an axial clearance is defined between the first shaft section and the bearing region of the bearing opening.

20. The air control apparatus according to claim 19, wherein at least a region of the second shaft section defines a hollow shaft having an engagement contour comprising an internal polygon profile.
